(19) United States
(12) Patent Application Publication
(10) Pub. No.: US 2012/0042724 A1
(43) Pub. Date: Feb. 23, 2012

(54) Method and device for checking the tire seat on vehicle wheels

(75) Inventors: Georg Lipponer, Zwingenberg (DE); Karl-Heinz Steitz, Mainz (DE)

(73) Assignee: Schenck RoTec GmbH, Darmstadt (DE)

(21) Appl. No.: 13/135,903

(22) Filed: Jul. 18, 2011

(30) Foreign Application Priority Data
Aug. 19, 2010 (DE) 10 2010 037 079.7

(51) Int. Cl. G01M 1/16

(52) U.S. Cl. 73/462

(57) ABSTRACT

In order to check the seat of a tubeless tire (3) fitted to a rim (2) of a vehicle wheel (1), the vehicle wheel (1) is fastened with its rim (2) centrically on a rotary mount and is rotated about its axis of rotation through at least one revolution. During rotation of the wheel, the outer contours of the radially outer edge areas of the rim (2) and the adjoining areas of the tire (3) are scanned by means of a distance measuring device, and the axial distance differences between the rim (2) and the tire (3) are detected and evaluated.

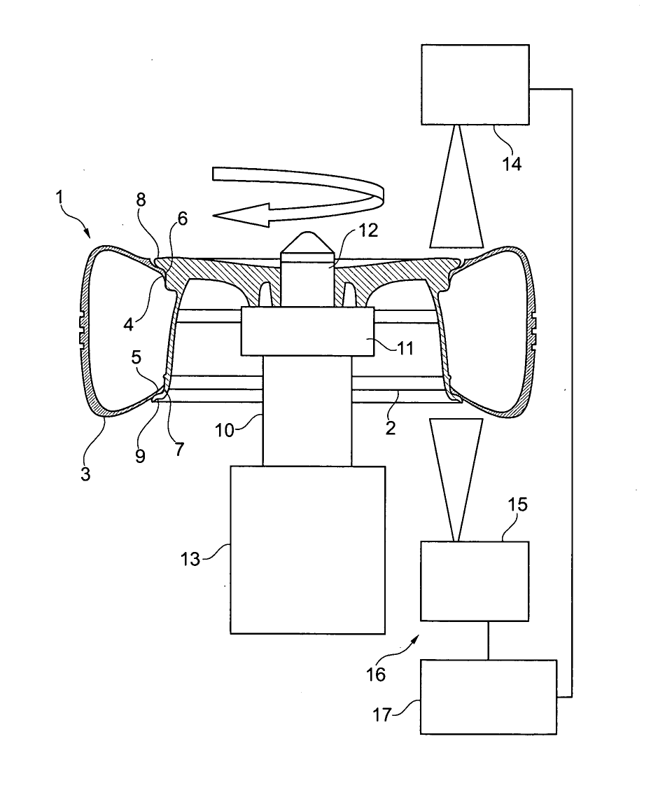

### CROSS REFERENCE TO RELATED APPLICATIONS

Applicants claim priority under 35 U.S.C. §119 of German Patent Application No. 10 2010 037 079.9 filed Aug. 19, 2010.

### FIELD OF THE INVENTION

This invention relates to a method and a device for checking the seat of a tubeless tire fitted to a rim of a vehicle wheel, said rim having on its peripheral edge annular walls which extend radially to the axis of rotation and form with their facing inner sides axial engagement surfaces for the tire beads.

### DESCRIPTION OF PRIOR ART

In volume production of vehicle wheels, the fitting of tires and rims is frequently performed on assembly lines using automatic equipment which mount the tire on the rim, inflate the tire and balance the assembled wheel. At the end of the assembly line checking devices may be installed which check the radial run-out of the tire tread and also the axial run-out of the tire sidewall. In practice, however, a recurring problem is that wheels which have been perfectly balanced and passed the check measurements without exception exhibit unbalanced conditions after the wheel has traveled a short distance only. It is assumed that such subsequently occurring unbalances are caused by a tire bead not having reached its complete sitting position on the rim while running under load. The need exists therefore for an improved check of the seat of the tire beads on the rim.

### SUMMARY OF THE INVENTION

It is an object of the present invention to provide a method suitable for checking the seat of the tire beads on the rim of a vehicle wheel. This method should allow implementation largely by automatic means and be suitable for integration into an assembly line for vehicle wheels.

According to the invention the method for checking the seat of a tubeless tire fitted to a rim of a vehicle wheel, said rim having on its peripheral edge annular walls which extend radially to the axis of rotation and form with their facing inner sides axial engagement surfaces for the tire beads comprises the steps of
fastening the vehicle wheel with its rim centrically on a rotary mount;
rotating the wheel about its axis of rotation through at least one revolution; during rotation of the wheel, scanning the outer contours of the radially outer edge area of an annular wall of the rim and the adjoining area of the tire by means of a distance measuring device;
detecting and evaluating differences in axial distance between the outer contour of the radially outer edge area of the annular wall of the rim and the outer contour of the adjoining area of the tire.

Surprisingly it has shown that an accurate measurement of axial position differences between the tire bead and the annular wall of the rim enables an incomplete seat of the tire bead to be detected with greater reliability than a measurement of the axial run-out on the tire sidewall. With the checking method of the invention it is therefore possible to reveal fitting defects, which later may result in unbalances, at an early moment and to correct this defect by appropriate repair work.

It will be understood, of course, that the check of the tire seat as disclosed in the invention may be performed on both annular walls of the rim either simultaneously or consecutively.

According to another proposal of the invention, a non-contact distance measuring device is used for scanning. Particularly advantageous is the use of a device in which a radially extending laser line illuminates the area to be scanned, the light reflection being evaluated by a high-speed camera employing the split-beam technique. Devices of this type are known and afford the advantage of enabling accurate measurements of the illuminated profile to be performed at a relatively large distance to the object being measured.

According to the present invention, it may be furthermore provided that a rotational angle sensor senses the rotational angle position of the wheel and that during evaluation the distance values detected by the distance measuring device are allocated to the angles of rotation of the respective measurement position. This enables the rotational angle position of an incorrect seating position of the tire bead to be determined and marked.

Apart from the detection of position differences between the annular wall of the rim and the tire it is possible according to another proposal of the invention to evaluate the measurement values of the distance measuring device also for determination of the axial run-out of the wheel. Moreover, it is possible for the detected position of the tire contour in the scanned area to be used for determining the clamping condition of the tire by comparing it with predetermined values.

For wheel location and rotation, an advantageous possibility afforded by the method of the invention includes the use of an unbalance measuring station provided for determining or checking the unbalance of the wheel. This obviates the need to incur the expenditure involved in constructing a separate rotary support for the wheel. It also makes the retrofitting of existing assembly installations particularly easy because it is only necessary to incorporate the required distance measuring devices into an existing unbalance measuring station.

An advantageous device according to the present invention comprises a rotary spindle for centrically locating a vehicle wheel, a device for rotating the spindle, a distance measuring device which is movable into a measurement position on the area of the vehicle wheel to be scanned, and an electronic evaluating device connected to the distance measuring device.

### BRIEF DESCRIPTION OF THE DRAWINGS

The present invention will be described in more detail in the following with reference to an embodiment illustrated in the accompanying drawing. The drawing shows schematically a device for checking the tire seat according to the invention.

### DETAILED DESCRIPTION OF THE DRAWINGS

The vehicle wheel 1 shown in the drawing in cross-section is composed of a rim 2 and a tubeless tire 3. The tire 3 has two tire beads 4, 5 seating solidly against seating surfaces 6, 7 on the outer periphery of the rim 2. In axial direction the tire beads 4, 5 bear against annular walls 8, 9 of the rim which extend radially outwardly adjacent to the seating surfaces 6, 7, forming with their sides facing the seating surfaces 6, 7 engagement surfaces for the tire beads 4, 5.

The wheel 1 is mounted on a rotary spindle 10. The spindle 10 has for this purpose a mount 11 with a plane radial mounting face and a clamping device 12 engaging in the central bore of the rim 2 to hold the rim 2 accurately centrally located on the spindle 10 and in a manner preventing relative rotation. The spindle 10 is arranged on, and adapted to be rotated by, a drive motor 13.

Arranged at a distance from the axis of rotation of the spindle 10 on both sides of the wheel 1 are sensors 14, 15 of an optical distance measuring device 16. The sensors 14, 15 are connected to an evaluating device 17 which processes the measurement signals of the sensors 14, 15 and evaluates them by computations according to predetermined criteria. Each of the sensors 14, 15 scans a lateral area of the wheel 1 covering some length from the radially outer edge of the annular walls 8, 9 radially inwardly and some length radially outwardly. With the wheel 1 rotating, the sensors 14, 15 thus scan an annular edge area of the rim 2 and an adjoining annular area of the tire 3. The distance measuring device 16 operates according to the split-beam method. In this method, the sensors 14, 15 illuminate the region of the wheel 1 to be scanned with an essentially radially oriented laser line and observe the projection of the laser line on the wheel 1 using an electronic high-speed camera. Using photogrammetry techniques, the evaluating device 17 converts the detected camera image of the lines into 3D coordinates from which the distance coordinates of the scanned contour can be computed.

To perform a check of the tire seat, the wheel 1 is set in rotation by means of the driven spindle, and the region on either side of the peripheral edge of the rim 2 is scanned and measured by means of the sensors 14, 15. The evaluating device 17 then uses the distance measurement values obtained to compute the differences in distance between the peripheral edges of the rim and the adjoining sidewalls of the tire 3 and compares these with a predetermined limit value. If the predetermined limit value is exceeded, an incorrect tire seat is assumed to be the case. Exceeded limit values are indicated visually or audibly. To eliminate the fault, the wheel 1 may then be removed from the production line and conveyed to a repair station.

The measurement run may be used at the same time for checking the lateral run-out of the wheel 1 and to provide an indication if predetermined limit values are exceeded.

What is claimed is:

1. A method for checking the seat of a tubeless tire fitted to a rim of a vehicle wheel, said rim having on its peripheral edge annular walls which extend radially to the axis of rotation and form with their facing inner sides axial engagement surfaces for the tire beads, comprising the steps of
fastening the vehicle wheel with its rim centrically on a rotary mount;
rotating the wheel about its axis of rotation through at least one revolution;
during rotation of the wheel, scanning the outer contours of the radially outer edge area of an annular wall of the rim and the adjoining area of the tire by means of a distance measuring device;
detecting and evaluating differences in axial distance between the outer contour of the radially outer edge area of the annular wall of the rim and the outer contour of the adjoining area of the tire.

2. The method according to claim 1, wherein a non-contact distance measuring device is used for scanning the areas of the wheel.

3. The method according to claim 2, further comprising using a device in which a radially extending laser line illuminates the area to be scanned, and the light reflection is detected by a high-speed camera and evaluated by the split-beam technique.

4. The method according to claim 1, wherein a rotational angle sensor senses the rotational angle position of the wheel, and the distance values detected by the distance measuring device are allocated to the angles of rotation of the respective measurement position.

5. The method according to claim 1, wherein the measurement values of the distance measuring device are evaluated for determination of the axial run-out of the wheel.

6. The method according to claim 1, wherein the detected position of the tire contour in the scanned area is used for determining the clamping condition of the tire by comparing it with predetermined values.

7. The method according to claim 1, wherein for locating and rotating the wheel an unbalance measuring station is used for determining or checking the unbalance of the wheel.

8. A device for implementing the method according to claim 1, wherein a rotary spindle for centrically locating a vehicle wheel, a device for rotating the spindle, a distance measuring device which is movable into a measurement position on or relative to the area of the vehicle wheel to be scanned, and an electronic evaluating device connected to the distance measuring device.

9. The device according to claim 8 comprising an unbalance measuring station.

10. The device according to claim 8, comprising a non-contact distance measuring device, with a line projector including a laser light source and designed to produce a radially extending laser line illuminating an area to be scanned, a high-speed camera detecting the light reflexion of the laser line, and an evaluating device evaluating the camera image employing the split-beam technique.
